(19) United States
(12) Patent Application Publication
(10) Pub. No.: US 2013/0145407 A1
(43) Pub. Date: Jun. 6, 2013

(54) Method of outputting video content from a computing device to a playback device and related media sharing system

(71) Applicants: Sheng Han, Hangzhou City (CN); Hongyan Zhao, Hangzhou City (CN)

(72) Inventors: Sheng Han, Hangzhou City (CN); Hongyan Zhao, Hangzhou City (CN)

(21) Appl. No.: 13/311,573

(22) Filed: Dec. 6, 2011

(51) Int. Cl. H04N 21/20

(52) U.S. Cl. 725/91

(57) ABSTRACT

A method of outputting video content from a computing device to a playback device includes executing a video viewing application on the computing device and browsing a video website on the computing device through the video viewing application, selecting video content to watch on the video website by navigating to a corresponding video webpage address through the video viewing application, and the video viewing application converting the video webpage address into a corresponding video file address. The method further includes selecting a playback device through the video viewing application, the selected playback device being in communication with the computing device, the video viewing application obtaining video data and obtaining audio data from the video file address and outputting the obtained video and audio data from the computing device to the selected playback device, and playing the obtained video data and the obtained audio data on the selected playback device.

### BACKGROUND OF THE INVENTION

1. Field of the Invention

The invention relates to a media sharing system, and more particularly, to a method of outputting downloaded video content from a computing device and outputting the video content to a playback device for playback on the playback device.

2. Description of the Prior Art

With consumer electronics becoming increasingly popular, there has been a trend to link electronic devices together in order to permit communication or sharing between various devices. However linking two or more devices together is not always a simple task.

For example, in order to connect a computer to a television (TV), either a direct cable connection or a wireless display (WiDi) connection is needed. Direct cable connections are also inconvenient and require cable to be run from one device to another which can be expensive and unsightly. Furthermore, in order to support WiDi requirements for communication between the computer and the TV, special hardware requirements are involved for both the computer and the TV. This may require either new hardware to be bought or upgrades to existing devices.

Furthermore, with standards such as the Digital Living Network Alliance (DLNA) and the Intelligent Grouping and Resource Sharing (IGRS), connectivity among multimedia devices is becoming more common. Interconnectivity among mobile phones, tablet computers, TVs, and other consumer appliances has become part of our daily lives. Pictures, audio, and video can easily be shared from mobile phones and tablet computers in order to be played on a device having a larger display. However, in order to accomplish this, two problems must be overcome.

First of all, the source computing device having the multimedia file to share must support DLNA, IGRS, or other connectivity standards for connecting to other multimedia devices. The source computing device must also support connecting to a local area network (LAN). Unfortunately, despite the popularity of Internet video, more and more source computing devices are not LAN compatible devices, and are especially not compatible with the DLNA or IGRS standards. Therefore, video from these source computing devices cannot be played on devices such as a TV. While Internet TVs can often support playback of video from some individual video sites, the Internet TVs cannot support all video websites, and it is not realistic to expect the Internet TVs to be upgraded to include this functionality.

Another problem is the ability to play modern video formats on TVs is relatively difficult. Now many popular video formats are supported on mobile phones and tablet PCs, but these video formats are not supported on most TVs. Thus, this becomes a big problem for Internet TVs wishing to support playback of Internet video.

### SUMMARY OF THE INVENTION

It is therefore one of the primary objectives of the claimed invention to provide a method of outputting video content from a computing device to a playback device for playing Internet video on the playback device.

According to an exemplary embodiment of the claimed invention, a method of outputting video content from a computing device to a playback device is disclosed. The method includes executing a video viewing application on the computing device and browsing a video website on the computing device through the video viewing application, selecting video content to watch on the video website by navigating to a corresponding video webpage address through the video viewing application, and the video viewing application converting the video webpage address into a corresponding video file address. The method further includes selecting a playback device through the video viewing application, the selected playback device being in communication with the computing device, the video viewing application obtaining video data and obtaining audio data from the video file address and outputting the obtained video data and obtained audio data from the computing device to the selected playback device, and playing the obtained video data and the obtained audio data on the selected playback device.

According to another exemplary embodiment of the claimed invention, a media sharing system for sharing video content includes a computing device comprising a video viewing application executable for browsing a video website on the computing device through the video viewing application, selecting video content to watch on the video website by navigating to a corresponding video webpage address through the video viewing application, converting the video webpage address into a corresponding video file address, selecting a playback device through the video viewing application, the selected playback device being in communication with the computing device, and obtaining video data and obtaining audio data from the video file address and outputting the obtained video data and obtained audio data from the computing device to the selected playback device. The media sharing system further includes the selected playback device playing the obtained video data and the obtained audio data received from the computing device.

It is an advantage that the present invention provides a convenient way to output Internet video selected through the video viewing application of the computing device to the selected playback device without the need to replace or upgrade hardware. The video viewing application can be used to select Internet video from any website and output this video data to the selected playback device. Therefore, the user can view the video data on the selected playback device having a larger screen instead of being limited to viewing the video data on the computing device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a media sharing system according to the present invention.

FIG. 2 is a flowchart describing the method of using a video viewing application to output video data from a computing device to a playback device according to the present invention.

### DETAILED DESCRIPTION

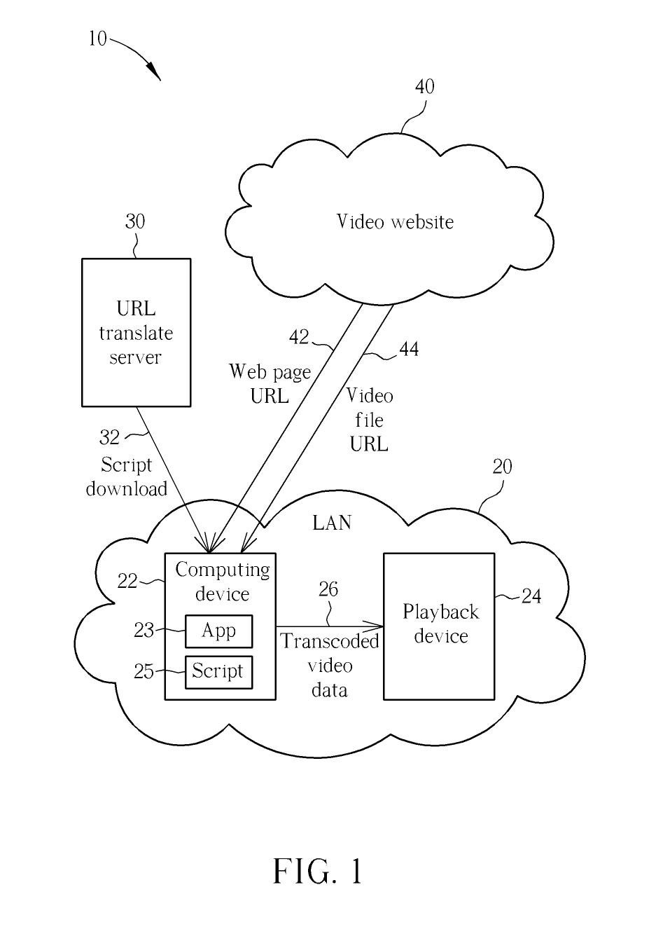

Please refer to FIG. 1. FIG. 1 is a block diagram of a media sharing system 10 according to the present invention. The media sharing system 10 includes a computing device 22 and a playback device 24 in communication with one another through a local area network (LAN) 20. The LAN 20 can be a wired network or a wireless network, with wireless or “WiFi” connections adhering to the IEEE 802.11 protocol. The computing device 22 includes a video viewing application 23 for accessing a video website 40 such as YouTube™, Dailymotion™, Vimeo®, and so on.

The computing device 22 and the playback device 24 preferably communicate with one another through the Digital Living Network Alliance (DLNA) protocol or the Intelligent Grouping and Resource Sharing (IGRS) protocol. The computing device 22 can be any device capable of connecting to the video website 40 through the Internet such as a mobile phone, a computer, a tablet computer, or a network attached storage (NAS) device. The playback device 24 can be any device that is capable of playing a video file such as a TV, a set top box, or a computer.

The video viewing application 23 is used to solve the prior art problems of Internet TVs not being able to play video from certain video websites or not being able to play video in the correct video format . The computing device 22 is a digital terminal that can received video data from the video website 40, transcode (if necessary) in real time the received video data into transcoded video data 26 having a format usable on the playback device 24, and transmit the transcoded data to the playback device 24 for real-time playback on the playback device 24. The playback device 24 is preferably a home entertainment device such as a TV, which allows Internet video to be played on a large screen supplied by the playback device 24. Using the computing device 22 such as a mobile phone or a tablet computer for viewing, transcoding, and transmitting video to the playback device 24 is more convenient than performing these functions on a traditional computer or a proprietary server. Furthermore, the total cost needed to implement the present invention is minimal.

Most video websites do not provide a direct address to a video file displayed on the video websites. Instead, the content of each webpage on the video websites contains data that can be converted into a direct address of the video file in order to provide the video file address information. For example, when a webpage uniform resource locator (URL) 42 is accessed by the computing device 22, the webpage content corresponding to the webpage URL 42 contains a video ID number corresponding to the video to be played. In order to convert this video ID number into a video file URL 44 that provides direct access to the video file, the video viewing application 23 contains a conversion script 25 for converting the video ID number into the video file URL 44.

Unfortunately, the content of webpages may change at any time, and website designers may change an algorithm used to convert the webpage content into a video file URL 44 as well. Therefore, in order to prevent these changes from affecting the ability of the video viewing application 23 to play video files, the video viewing application 23 needs to update the conversion script 25 in order to provide the ability to access video files correctly. The conversion script 25 can be updated when a new version of the video viewing application 23 is released. In another embodiment, a server 30, such as a featherweight server can be used to store the conversion script 25 for download by the video viewing application 23 . The video viewing application 23 can periodically check the server 30 to determine if the server 30 contains a newer version of the conversion script 25 than what is present on the computing device 22. If a newer version of the conversion script 25 is available on the server, the video viewing application 23 will perform a script download 32 of the newer version of the conversion script 25. In this way, as long as the video viewing application 23 user has updated to the most recent conversion script 25, video files from the video website 40 can be guaranteed to play.

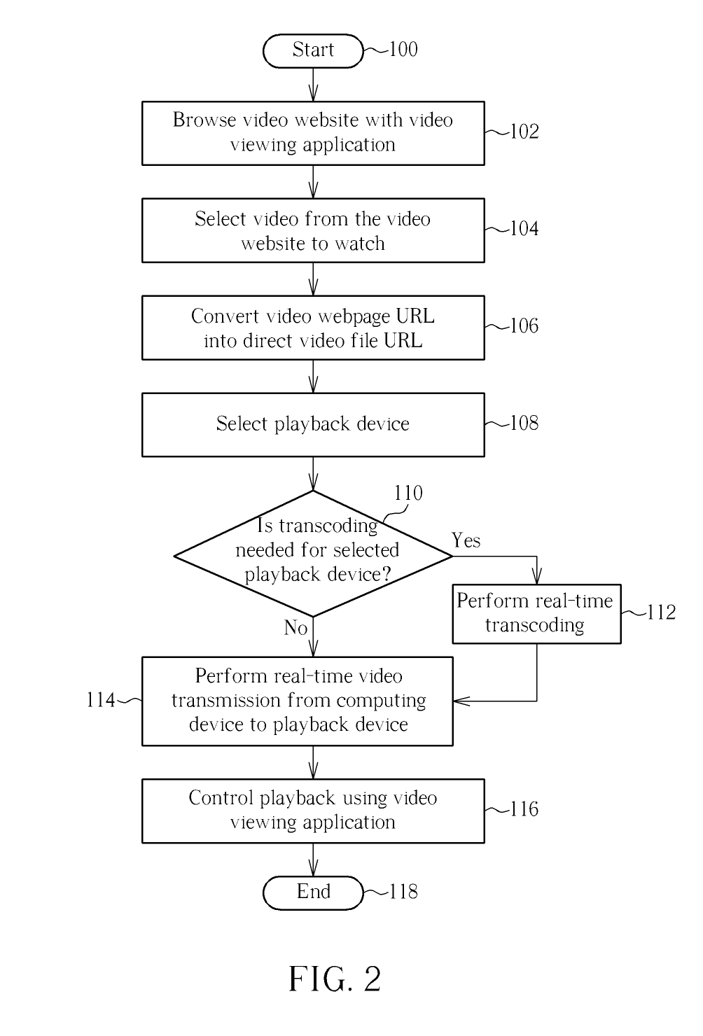

Please refer to FIG. 2. FIG. 2 is a flowchart describing the method of using the video viewing application 23 to output video data from the computing device 22 to the playback device 24 according to the present invention. Steps in the flowchart will be explained as follows.

Step 100: Start.

Step 102: A user of the computing device 22 uses the video viewing application 23 to browse the video website 40.

Step 104: The user selects a video from the video website 40 to watch.

Step 106: The video viewing application 23 converts the video ID number corresponding to the webpage URL 42 into the direct video file URL 44 for providing a direct link to the video file. Video data and audio data corresponding to the video file are then obtained.

Step 108: The user selects the playback device 24 to be used for playback. The playback device 24 is a connected digital multimedia device such as a TV that supports the DLNA standards or other similar connectivity standards for communicating with the computing device 22.

Step 110: The video viewing application 23 determines whether transcoding is needed on the video file in order for the playback device 24 to support playback of the video file pointed to by the video file URL 44. If transcoding is needed because the playback device 24 cannot support the video format of the video file, go to step 112. Otherwise, if no transcoding is needed because the playback device 24 can already support the video format of the video file, go to step 114.

Step 112: The video viewing application 23 controls the computing device 22 to transcode the video file pointed to by the video file URL 44 in real time. Obtained video data of the video file is then transcoded into encoded video data and obtained audio data of the video file is then transcoded into encoded audio data. The encoded video data and the encoded video data are in formats that are playable by the playback device 24.

Step 114: Video and audio data are output from the computing device 22 to the playback device 24 in real time. If no transcoding took place in step 112, the video viewing application 23 controls the computing device 22 to output the obtained video data and the obtained audio data to the playback device 24. Otherwise, if transcoding did take place in step 112, the video viewing application 23 controls the computing device 22 to output the encoded video data and the encoded audio data to the playback device 24.

Step 116: The video viewing application 23 controls playback of the video file on the playback device 24. The video viewing application 23 can execute such functions as pausing, resuming, jumping to another location for playback, volume control, and so on.

Step 118: End.

In summary, the present invention provides a way for outputting Internet video selected through the video viewing application of the computing device to a selected playback device without the need to replace or upgrade hardware of the selected playback device. The video viewing application can be used to select Internet video from any website and output this video data to the selected playback device. Therefore, the user can enjoy viewing the video data on the selected playback device having a larger screen instead of being limited to viewing the video data on the computing device.

Those skilled in the art will readily observe that numerous modifications and alterations of the device and method may be made while retaining the teachings of the invention. Accordingly, the above disclosure should be construed as limited only by the metes and bounds of the appended claims.

1. A method of outputting video content from a computing device to a playback device, the method comprising:
executing a video viewing application on the computing device and browsing a video website on the computing device through the video viewing application;
selecting video content to watch on the video website by navigating to a corresponding video webpage address through the video viewing application;
the video viewing application converting the video webpage address into a corresponding video file address;
selecting a playback device through the video viewing application, the selected playback device being in communication with the computing device;
the video viewing application obtaining video data and obtaining audio data from the video file address and outputting the obtained video data and obtained audio data from the computing device to the selected playback device; and
playing the obtained video data and the obtained audio data on the selected playback device.

2. The method of claim 1, wherein the video viewing application obtains video data and obtains audio data from the video file address and outputs the obtained video data and the obtained audio data from the computing device to the selected playback device in real time.

3. The method of claim 1 further comprising:
the video viewing application determining video formats and audio formats for which the selected playback device is capable of playing; and
the video viewing application transcoding the obtained video data into encoded video data and transcoding the obtained audio data into encoded audio data when the selected playback device is not capable of playing a video format of the obtained video data or playing an audio format of the obtained audio data, wherein the encoded video data and the encoded audio data are respectively in a video format and an audio format for which the selected playback device is capable of playing;
wherein outputting the obtained video data and obtained audio data from the computing device to the selected playback device comprises outputting the encoded video data and the encoded audio data from the computing device to the selected playback device, and
wherein playing the obtained video data and the obtained audio data on the selected playback device comprises playing the encoded video data and the encoded audio data on the selected playback device.

4. The method of claim 3, wherein the video viewing application obtains video data from the video file address, transcodes the video data into encoded video data, obtains audio data from the video file address, transcodes the audio data into encoded audio data, and outputs the encoded video data and the encoded audio data from the computing device to the selected playback device in real time.

5. The method of claim 1 further comprising utilizing a conversion script when the video viewing application converts the video webpage address into the corresponding video file address.

6. The method of claim 5 further comprising:
determining a version of the conversion script stored on the computing device and used by the video viewing application;
accessing a server for determining a most recent version of a conversion script stored on the server; and
downloading the most recent version of the conversion script from the server to the computing device when the video viewing application determines that the most recent version of the conversion script stored on the server has been updated more recently than the version of the conversion script stored on the computing device and used by the video viewing application.

7. The method of claim 1, wherein the Digital Living Network Alliance (DLNA) protocol is used for communication between the computing device and the selected playback device.

8. The method of claim 1, wherein the computing device is a mobile phone, a computer, a tablet computer, or a network attached storage (NAS) device.

9. The method of claim 1, wherein the selected playback device is a television, a set top box, or a computer.

10. The method of claim 1, wherein while the selected playback device is playing the obtained video data and the obtained audio data the computing device controls playback options including pausing, resuming, and volume control.

11. A media sharing system for sharing video content, the media sharing system comprising:
a computing device comprising a video viewing application executable for browsing a video website on the computing device through the video viewing application, selecting video content to watch on the video website by navigating to a corresponding video webpage address through the video viewing application, converting the video webpage address into a corresponding video file address, selecting a playback device through the video viewing application, the selected playback device being in communication with the computing device, and obtaining video data and obtaining audio data from the video file address and outputting the obtained video data and obtained audio data from the computing device to the selected playback device; and
the selected playback device playing the obtained video data and the obtained audio data received from the computing device.

12. The media sharing system of claim 11, wherein the video viewing application obtains video data and obtains audio data from the video file address and outputs the obtained video data and the obtained audio data from the computing device to the selected playback device in real time.

13. The media sharing system of claim 11, wherein the video viewing application determines video formats and audio formats for which the selected playback device is capable of playing, and the video viewing application transcodes the obtained video data into encoded video data and transcodes the obtained audio data into encoded audio data when the selected playback device is not capable of playing a video format of the obtained video data or playing an audio format of the obtained audio data, wherein the encoded video data and the encoded audio data are respectively in a video format and an audio format for which the selected playback device is capable of playing, and the video viewing application outputs the encoded video data and the encoded audio data from the computing device to the selected playback device, and the selected playback device plays the encoded video data and the encoded audio data.

14. The media sharing system of claim 13, wherein the video viewing application obtains video data from the video file address, transcodes the video data into encoded video data, obtains audio data from the video file address, transcodes the audio data into encoded audio data, and outputs the encoded video data and the encoded audio data from the computing device to the selected playback device in real time.

15. The media sharing system of claim 11 wherein the video viewing application uses a conversion script for converting the video webpage address into the corresponding video file address.

16. The media sharing system of claim 15, further comprising:
a server for hosting a most recent version of the conversion script;
wherein when the video viewing application determines that the most recent version of the conversion script stored on the server has been updated more recently than the version of the conversion script stored on the computing device and used by the video viewing application, the video viewing application downloads the downloading the most recent version of the conversion script from the server to the computing device.

17. The media sharing system of claim 11, wherein the Digital Living Network Alliance (DLNA) protocol is used for communication between the computing device and the selected playback device.

18. The media sharing system of claim 11, wherein the computing device is a mobile phone, a computer, a tablet computer, or a network attached storage (NAS) device.

19. The media sharing system of claim 11, wherein the selected playback device is a television, a set top box, or a computer.

20. The media sharing system of claim 11, wherein while the selected playback device is playing the obtained video data and the obtained audio data the computing device controls playback options including pausing, resuming, and volume control.
